(19) United States
(12) Patent Application Publication
(10) Pub. No.: US 2008/0097802 A1
(43) Pub. Date: Apr. 24, 2008

(54) Time-Series Forecasting

(75) Inventors: Cedric Ladde, London (GB); Anargyros Garyfalos, Ipswich (GB)

Correspondence Address: NIXON & VANDERHYE, PC, 901 NORTH GLEBE ROAD, 11TH FLOOR, ARLINGTON, VA, 22203, US

(73) Assignee: BRITISH TELECOMMUNICATIONS PUBLIC LIMITED COMPANY, London (GB)

(21) Appl. No.: 11/795,042

(22) PCT Filed: Feb. 6, 2006
(86) PCT No.: PCT/GB06/00396

§ 371 Date: Jul. 11, 2007

(30) Foreign Application Priority Data
Feb. 7, 2005 (GB) 0502494.8

(51) Int. Cl. G06Q 10/00; G06F 17/00

(52) U.S. Cl. 705/7

(57) ABSTRACT

A forecasting system is regulated with time-series data. The context of the time-series data is determined by one or more parameters encapsulated within a forecast data type, the forecast data type being arranged to present the time-series data in a generic form (independent of any context information) to a forecasting algorithm of the forecasting system. The time-series data is encapsulated to enable the forecasting algorithm to generate a forecast for the time-series dependent on such context. The time-series data is retrieved using a generic forecast data type object arranged to provide the time-series in the predetermined context. The context presented by the fore-cast data type is capable of changing by the fore-cast data type representing a variable number and type of parameters to the forecasting system without requiring the forecasting system to be re-configured to provide the forecast over the time-series data.

This invention relates to time-series forecasting in which a forecast system is provided with time-series data by using a single generic data entity to represent a plurality of different forecasting parameters.

As demand for more accurate forecasts rises, the size of data sets over which a forecast is to be generated can increase and a data set over which a forecast is sought may contain data with different contexts and/or at different levels of granularity. Modern forecasting algorithms not only have to cope with time-series data which may represent averages obtained over different periods of time, but different levels of granularity can occur in time-series data in dimensions other than time, for example, different spatial contexts (e.g. the area over which the data was collated) and/or other different contexts can occur. Time-series data parameters may also be related by hierarchies or more complex rule-based relationships. Where the time-series data over which a forecast is to be obtained differs in terms of the context (nature and/or relationship to other data and/or level of granularity and/or even data format etc., etc) and type of parameters, the data which does not conform with the forecast requirements may be ignored or subjected to pre-processing to map it into a form suitable for generating a forecast. If a forecasting algorithm incorporates means to pre-process data however, unanticipated variations in the context and/or parameter types of the time-series data over which a forecast is to be obtained requires the forecasting algorithm itself to be re-configured.

Adapting forecasting algorithms to recognize data having different contexts and to be also capable of utilizing such data (rather than simply ignoring it when determining a forecast) requires more complex programming which increases the cost of obtaining forecasts. The need to pre-process data also increases the time to generate a forecast, and only data which the forecast system developer anticipated being of a type capable of being pre-processed can be used to generate a forecast.

Technical fields relying on time-series forecasting include the automobile, aeronautical, medical and engineering fields. An example of a technical forecasting application is an application to forecast component failure (e.g. metal fatigue). Some technical applications use forecasts to anticipate a negative result which is then automatically compensated for using a feedback mechanism. In this way, forecast results can be automatically mitigated or obviated when undesirable. Physical systems may use fore-cast results in time-critical applications where the forecast must be determined rapidly to enable steps to be taken to prevent the unwanted result from occurring.

As a system grows, it may be necessary to amalgamate different data sets over which the forecast is to be obtained (or to incorporate different features which are subsequently found to impact the forecast). If an existing forecasting system cannot utilize the additional data, then no forecasts can be obtained until the forecasting algorithm is corrected or replaced to allow the additional data to be utilized. Customizing a time-series forecasting system so that it is able to provide forecasts for specific requirements can be a complex, costly task involving considerable reconfiguration of the forecasting algorithms. A forecast system designer may need to reconfigure conventional forecasting systems each as additional parameters are introduced or deleted from the time-series data used by the forecast model of the forecast system. As an example, consider the case where a forecast is required in order to ensure appropriate resources are available. In order to produce accurate forecasts, numerous parameters need to be considered like geographic area, type of resource. If reconfiguration of the forecasting algorithm is required each time the forecasting model is changed, cost and delay in forecast generation is incurred.

In many scenarios, the plethora of potential forecasting parameters may cause problems, as it may not be clear when the forecasting tool is being developed, which are required to ensure the forecast is satisfactorily accurate. Developing a time-series forecasting tool is a complicated task with many parts of critical importance and is usually undertaken by skilled application developers. Even so, dealing with new parameters on every customer instance is a costly and time consuming process.

In United States Patent Application No. US2002/0133385A1, entitled “Method and computer program product for weather adapter consumer event planning”, by F. Fox, D. Pearson et all., there is a specification of a system forecasting future retail performance in which a basic architecture consisting of an analyzer and a configurator which selects the specific parameters to be forecast over. However, if the parameters used in the model change, then the configurator will have to be modified accordingly, in addition to the required database changes. Similarly, in USA Patent Application No. US 2002/0169657A1 entitled “Supply chain demand system and forecasting”, by N. Singh, S. Olasky et all., a forecasting system is described which supports multi-scenario comparisons. However, this system uses different algorithms for different scenarios and does not deal with parameters in a generic and extensible way has not bee tackled.

The invention seeks to obviate and/or mitigate the limitations of known forecasting algorithms. For example, by obviating or mitigating the need to reconfigure a forecasting algorithm each time the model on which it is based changes by providing a generic forecasting tool which is able to accommodate any number and type of parameters, and which is able to modify existing parameters dynamically during the operation of the system. This reduces the skill set required to generate forecasts using time-series data having different contexts and/or parameters and/or parameter types (for example, where the time-series data has varying levels of granularity) by encapsulating the time-series data within a single generic data structure (via a forecasting data type). This encapsulation of data enables the forecast algorithm to be simplified as it removes any need for the forecasting algorithm to incorporate means to pre-process the time-series data. This simplifies the programming complexity of the forecasting algorithm, and enables faster forecasts to be obtained despite allowing forecasts to be generated from time-series which have differing contexts and/or parameters and/or parameter types (as the forecast data type can represent time-series data which comprises more than one type or level of data encapsulation). The need for the forecasting algorithm to pre-process data is removed as the time-series data is pre-processed (also known as being “groomed”) separately and is effectively provided in a pre-processed format to the forecasting algorithm. This also enables forecasts to be obtained using different data series dynamically without requiring the algorithm to be re-configured.

The invention also seeks to provide a forecasting data type (FDT) which abstracts all different forecasting parameters into a single entity. This enables forecasting systems to be developed which are as generalized as possible and remove the need for the application developer to have to modify the forecasting system for every new set of customer requirements.

A first aspect of the invention seeks to provide a method of populating a forecasting system with time-series data, wherein the context of the time-series data is determined by one or more parameters encapsulated within a forecast data type, the forecast data type being arranged to present the time-series data in a generic form independent of any context information to a forecasting algorithm of the forecasting system, wherein the time-series data is encapsulated to enable the forecasting algorithm to generate a forecast for the time-series dependent on said context, the method comprising:
retrieving the time-series data using a generic forecast data type object, said generic forecast data type object being arranged to provide said time-series in said pre-determined context, wherein said context presented by said fore-cast data type is capable of changing by said fore-cast data type representing a variable number and type of parameters to the forecasting system without requiring the forecasting system to be re-configured to provide the forecast over the time-series data.

The invention thus provides a way for a forecasting engine to utilize large and more complex time-series data. The forecasting engine receives data which is in a generic form and so avoids the processing burden associated with pre-processing time-series data into a form appropriate for generating a forecast over. The time to generate the forecast is thus reduced, enabling more forecasts to be provided in a given period. This is advantageous in technical fields where data prediction is time-critical. For example, if auto-correction to some component of a physical system is to be provided on the basis of the prediction from the time-series forecast, rapidly determining the forecast may be essential.

Mapping time-series data into a generic forecast data type is similar to “grooming” the time-series data for the forecasting system. As the system itself only perceives “groomed” data, additional data can be dynamically considered by the forecasting algorithm. There is no need to reconfigure the forecasting algorithm each time new types of data are to be included in the time-series data over which the forecast is to be generated.

In one embodiment, the number of parameters providing the time-series data with the pre-determined context is modified by the forecast data type during the operation of the forecasting system.

In one embodiment, the type of at least one parameter providing the time-series data with its pre-determined context is modified by the forecast data type during the operation of the forecasting system.

In one embodiment, the forecasting data type is arranged to provide a plurality of parameters which form a hierarchy.

In one embodiment, the forecasting data type is arranged to provide a plurality of parameters which do not form a hierarchy.

In one embodiment, said forecast system comprises a forecast application arranged to parse received parameters required by a forecasting model of the forecast system, and wherein the forecast data type (FDT) is arranged to enable said forecast application to parse a plurality of different parameters required by said forecast model to enable a plurality of different forecast strategies to be applied on said parameters without the need to reconfigure the forecast algorithm.

In one embodiment, the abstract FDT represents leaf parameters of the time-series data over which a forecast is to be obtained.

In one embodiment, the forecast data type represents leaf parameters in such a way that aggregate data can be determined dynamically and provided to the forecast algorithm.

A second aspect of the invention seeks to provide a forecast system comprising a forecasting application and a forecast model, the forecast model being arranged to access a plurality of differing types of parameter time-series, each differing type of parameter time-series being accessed in the appropriate context by the forecast model receiving a set of time-series database entries, in which the forecast model itself is not able to distinguish between different parameters.

A third aspect of the invention seeks to provide a forecast data type (FDT) arranged to provide a forecasting system with time-series data having a pre-determined context represented by a predetermined number of differing parameters, each having a predetermined parameter type, the forecasting system comprising a forecasting application arranged to parse the different parameters required by a forecast model of said forecast system, said forecast data type being arranged to provide said parameters in a relevant context to enable different strategies to be applied on said parameters without the need to reconfigure the forecast algorithm.

Another aspect of the invention seeks to provide a forecast data type object comprising an object of the forecast data type as claimed in claim 10, in which each FDT object associates four different logical entities which collectively apply the relevant context information to the leaf level parameter time-series data.

In one embodiment, one logical entity comprises a set of data arranged to identify the attributes of the FDT object.

In one embodiment, another logical entity of the FDT object comprises a set of data arranged to maintain the hierarchical relationship among all the identified attributes of the FDT object.

In one embodiment, another logical entity of the FDT object is arranged to store information associated with each identified attribute of the FDT object.

In one embodiment, another logical entity of the FDT object represents said time-series data used by said forecasting algorithm by retrieving appropriate historical values for said leaf level parameters from a data store comprising said historical leaf level parameters and their associated values.

In one embodiment, the FDT object is arranged to represent the historical values of a particular leaf level parameter to ensure the time-series data passed to the forecasting algorithm has an appropriate context.

In one embodiment, said logical entity comprises: a system generated identifier to identify each attribute uniquely; a description of the attribute; a data store associated with at least one other data store arranged to provide leaf-level parameter values.

In one embodiment, said logical entity comprises for each attribute: a primary key associated with the data store associated with the attribute; an attribute type; any parent attribute of the attribute; an attribute level; an attribute name.

In one embodiment, said logical entity comprises: the FDT identifier for said forecast data type object; at least one attribute type for the FDT object; and at least one attribute identifier for the FDT object.

In one embodiment, said logical entity comprises: a historical value for the FDT object; a time value associated with said historical value; and an FDT object identifier for said historical value.

Another aspect of the invention relates to a forecasting system arranged to be customized for specific forecasting requirements by customizing the population of the table entries of the forecast data type object aspect.

Another aspect relates to a method of populating a forecasting system with time-series data having a pre-determined context represented by a predetermined number of parameters, each having a predetermined parameter type, the forecasting system being arranged to generate a forecast for the time-series dependent on said context, the method comprising: retrieving the time-series data using a generic forecast data type object, said generic forecast data type object being arranged to provide said time-series in said pre-determined context, wherein said context may be presented by said fore-cast data type providing a variable number and type of parameters to the forecasting system without requiring the forecasting system to be re-configured to provide the forecast over the time-series data.

Another aspect relates to a method of forecasting using time-series data comprising the steps of: encapsulating one or more parameters representing the context of the time-series data within a forecast data type; presenting the time-series data using said forecast data type in a generic form independent of any context information to a forecasting algorithm of a forecasting system; populating the forecasting system with time-series data; and generating a forecast by a forecast algorithm of the forecasting system receiving said the time-series data from the forecast system, and using said data to generate a forecast; wherein, in said step of populating the forecasting system with time-series data, the time-series data is retrieved using a generic forecast data type object, said generic forecast data type object being arranged to provide said time-series in said pre-determined context, and wherein said context presented by said fore-cast data type is capable of changing by said fore-cast data type object representing a variable number and type of parameters to the forecasting system, wherein said fore-cast data type is arranged to provide a different number and/or type of parameters to the forecast system without requiring the forecasting algorithm to be re-configured to provide the forecast over the time-series data.

Another aspect relates to a method of pre-processing time-series data to populate a forecasting system independently of the type or context of the time-series data, wherein the forecasting system is arranged to generate a forecast for each type of time-series data dependent on said context and type, the method comprising the steps of: determining the context of each type of time-series data, wherein the context is represented by one or more parameters of one or more parameter types, mapping each time-series data to one or more forecast data type objects by encapsulating the time-series data and its context within a generic forecast data type, whereby said forecast data type objects are capable of presenting said time-series data and said context in encapsulated form to said forecasting system, whereby said forecasting system populated with said encapsulated time-series data and said context using said generic forecast data type object is arranged to process said received forecast data type objects to generate a forecast for said time-series.

In one embodiment, said time-series data pre-processed to populate said forecasting system includes data having differing contexts and/or capable of being differently encapsulated with their context(s), whereby said forecast data type objects are arranged to present said differently encapsulated time-series data and context(s) in a generic form to the forecasting system.

Another aspect relates to a method of operating a forecasting system to generate a forecast using a generic data structure, the generic data structure being arranged to encapsulate data at one or more different context levels, the method comprising: populating the forecasting system independently of the context of the time-series data over which a forecast is to be obtained, wherein the forecasting system is arranged to generate a forecast for each type of time-series data dependent on said context and type, by: determining the context of each type of time-series data, wherein the context is represented by one or more parameters of one or more parameter types, mapping each time-series data to one or more forecast data type objects by encapsulating the time-series data and its context within a generic forecast data type, presenting said time-series data in an encapsulated form to said forecasting systems using said forecast data type objects, and processing said encapsulated time-series data to generate a forecast for said time-series, wherein said forecasting system automatically determines from each received forecast data type the context for generating a forecast using the time-series data.

In one embodiment, the forecast for the time-series data is generated by the forecasting system at the same encapsulation level as the encapsulated time-series.

In one embodiment, the forecast system generates a forecast using said encapsulated data at a differing level of encapsulation from the encapsulated time-series.

Another aspect relates to a database of stored forecast data type objects, the objects arranged for use in any of the method aspects.

Another aspect relates to apparatus arranged to support the operation one or more computer programs, wherein said one or more computer programs, when implemented on said apparatus, are arranged to perform appropriate steps in any method aspect. Those skilled in the art will appreciate that the above aspects are as defined in the independent claims and that the aspects may be combined with each other and with any appropriate embodiments in any suitable manner apparent to those skilled in the art.

Thus the invention provides a sophisticated abstraction which hides the specific characteristics of any set of forecasting parameters, thus providing the system with a single and stable interface. Parameters can now be added, removed and even modified without any modification required to the forecasting application. Re-usability and extensibility of the system are therefore increased.

The preferred embodiments of the invention will now be described with reference to the accompanying drawings which are by way of example only and in which:

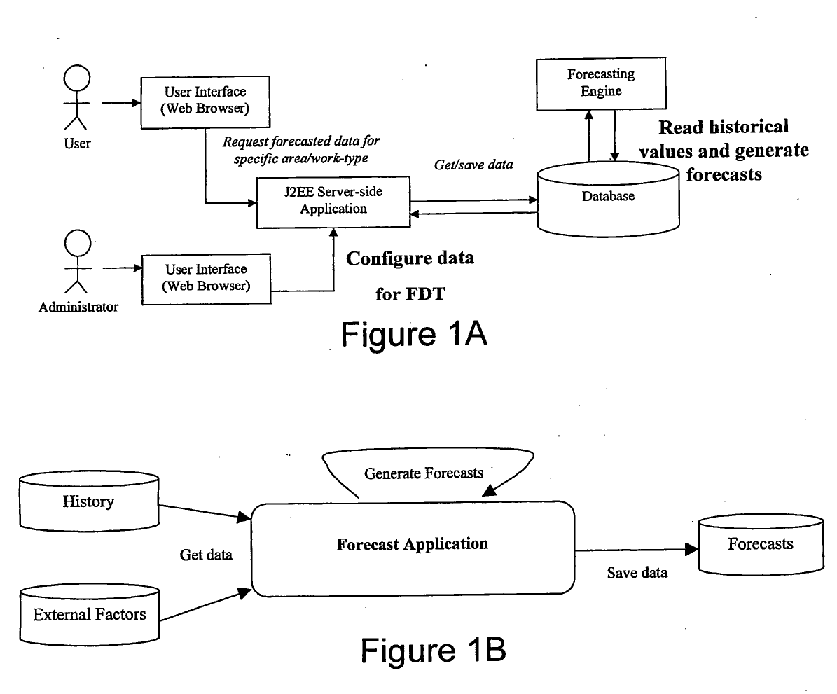

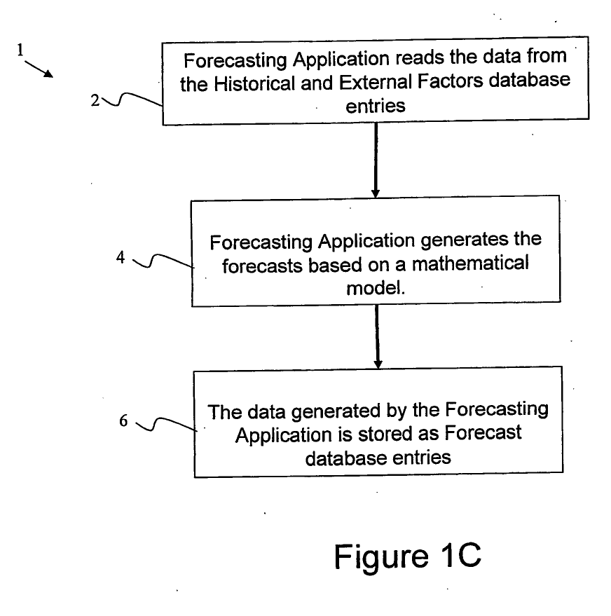

FIG. 1A shows schematically an overview of a forecasting application which is arranged to receive time-series data via a forecast data type according to one embodiment of the invention;

FIG. 1B shows schematically a basic forecasting system comprising a forecasting application as shown in FIG. 1A;

FIG. 1C shows steps in a basic forecasting system of FIG. 1B;

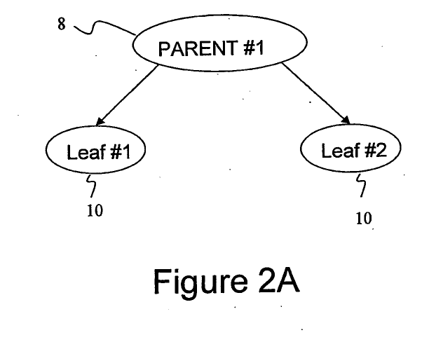

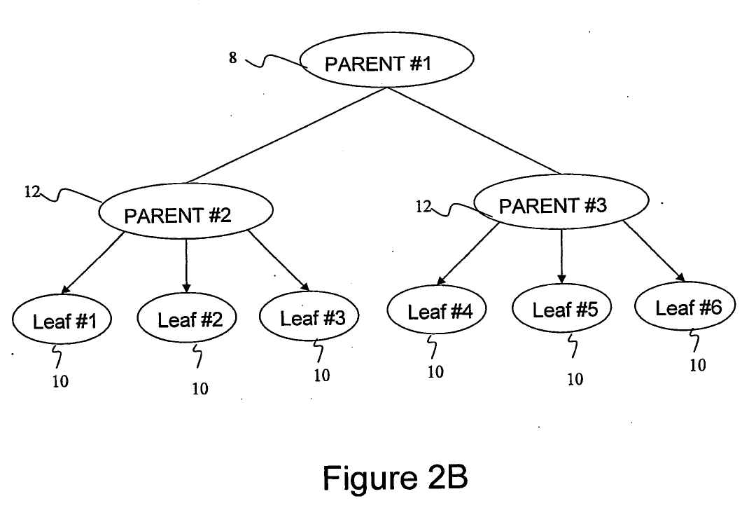

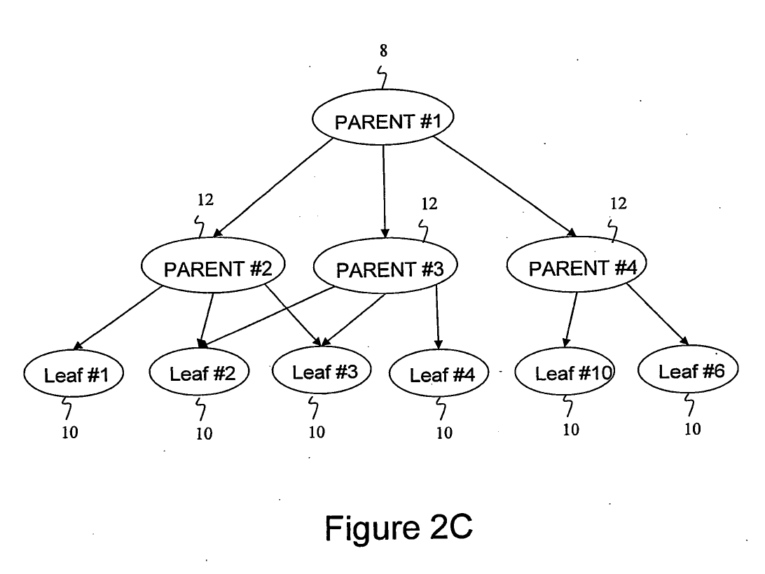

FIG. 2A shows a two-level hierarchical forecasting parameter relationship;

FIG. 2B shows a three-level hierarchical forecasting parameter relationship;

FIG. 2C shows a three-level non-hierarchical forecasting parameter relationship;

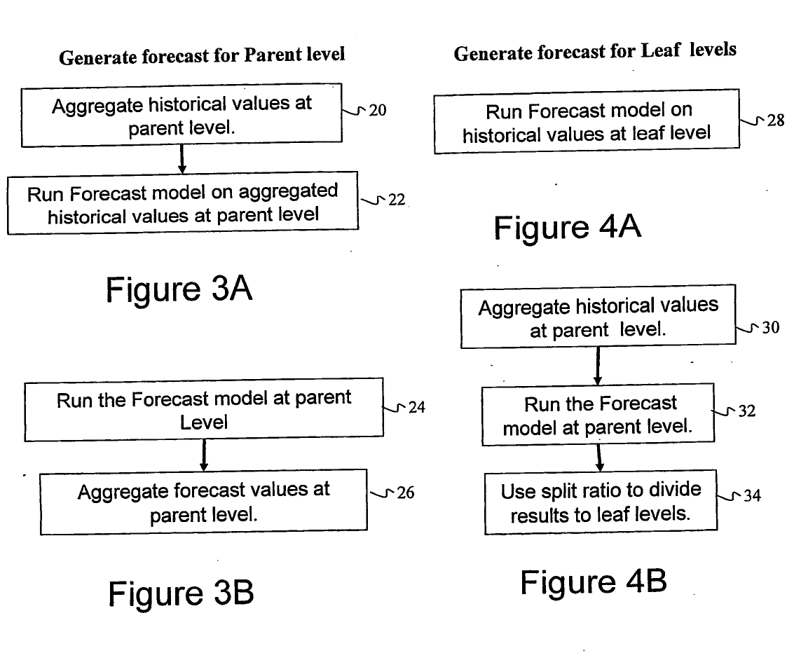

FIGS. 3A and 3B show steps in method of generating forecasts at the level of a parent parameter;

FIGS. 4A and 4B show steps in a method of generating forecasts at the level of a leaf parameter;

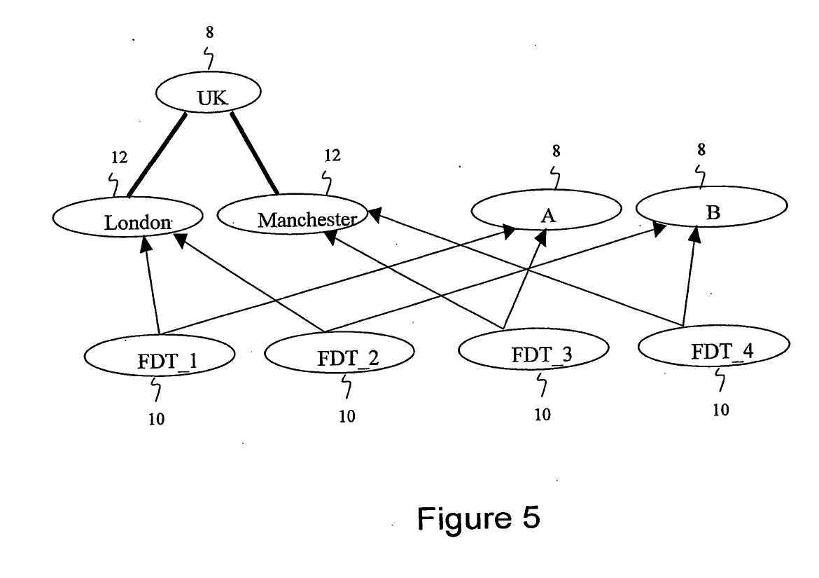

FIG. 5 shows how a forecasting data type may be used in a two-level hierarchical forecasting parameter relationship according to one embodiment of the invention;

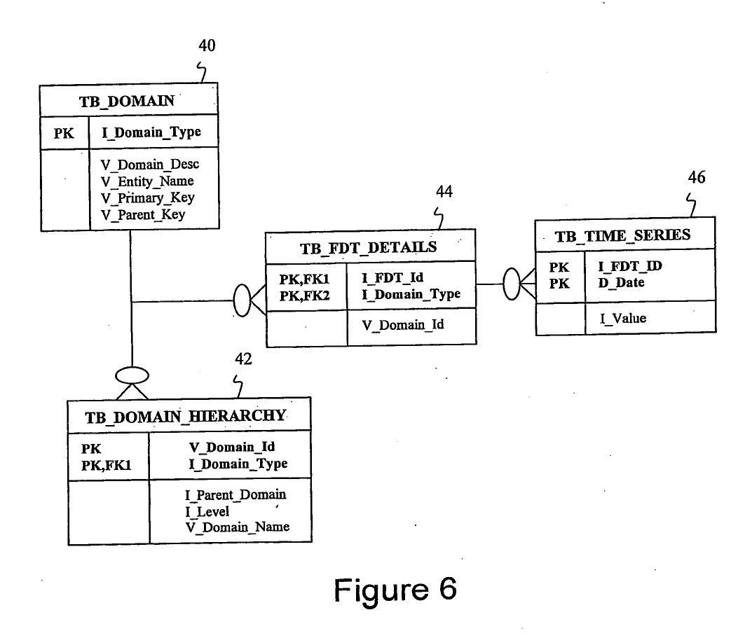

FIG. 6 shows how the context of the leaf parameters is represented in a forecasting data type according to embodiments of the invention;

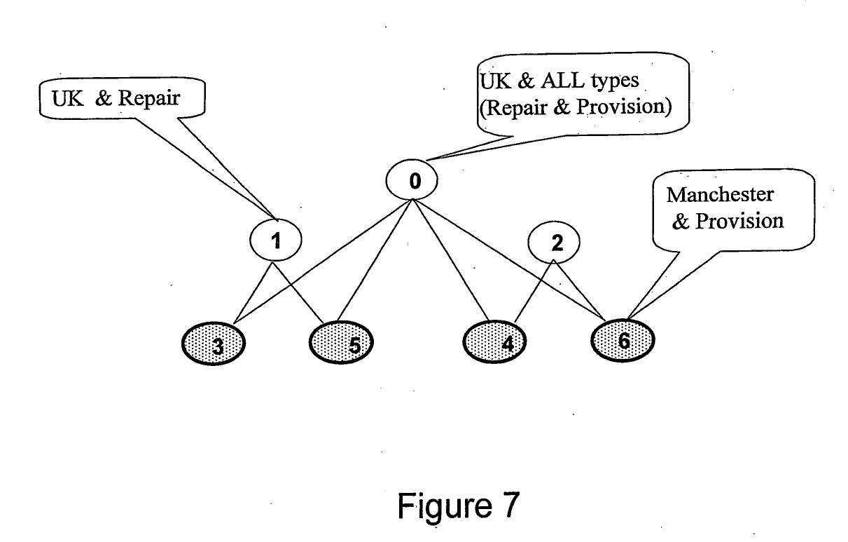

FIG. 7 shows the values of the parameters in a forecasting parameter relationship according to one embodiment of the invention;

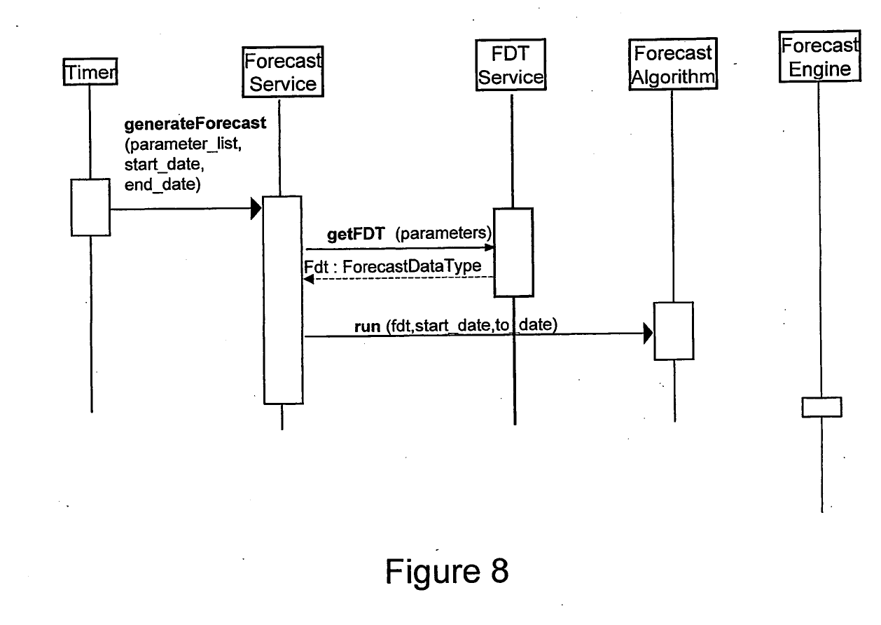

FIG. 8 shows the workflow according to an embodiment of the invention;

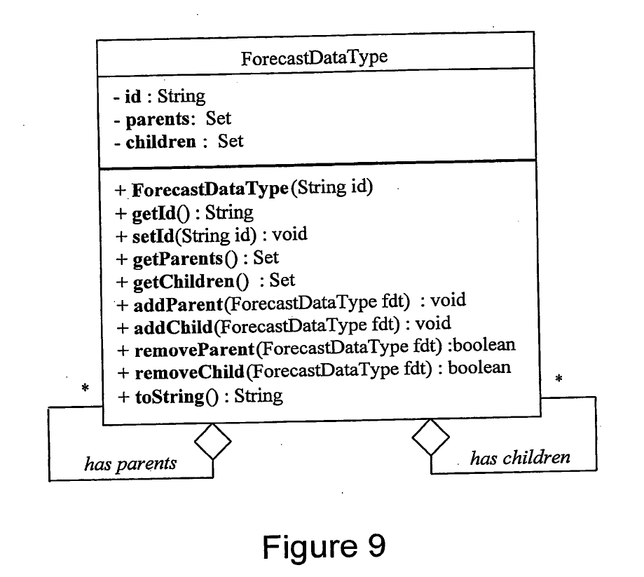

FIG. 9 shows a class diagram of a forecast data type according to one embodiment of the invention;

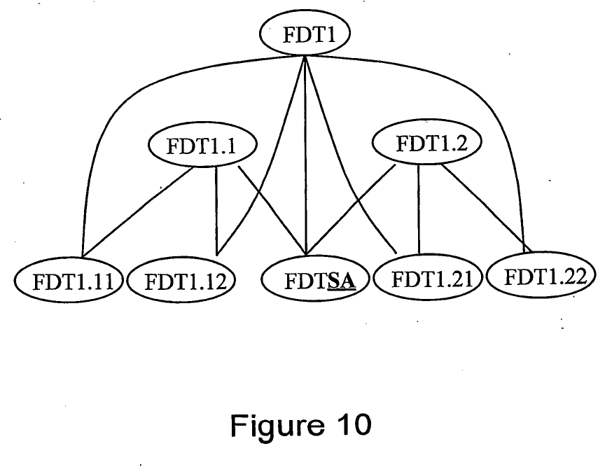

FIG. 10 shows a non-hierarchical parameter relationship according to another embodiment of the invention;

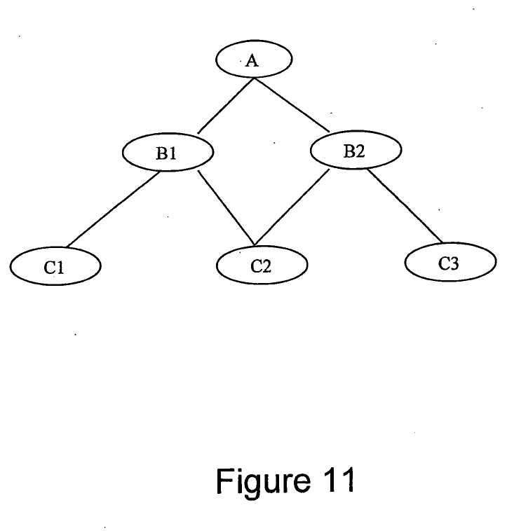

FIG. 11 shows a new work type hierarchy structure according to one embodiment of the invention; and

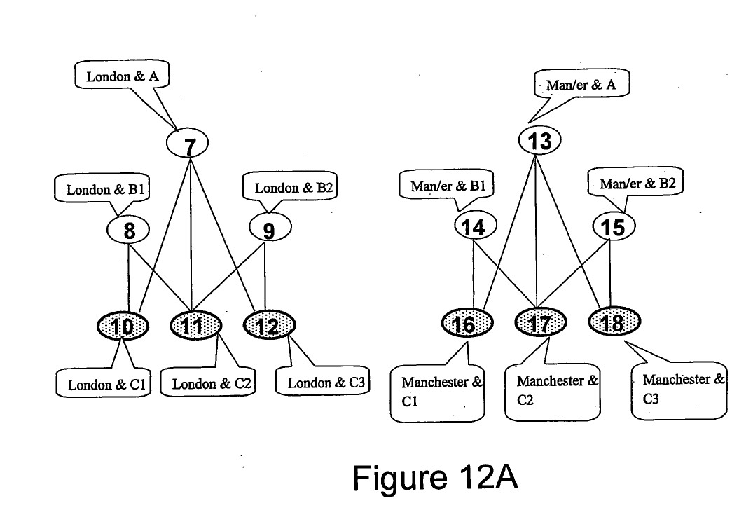

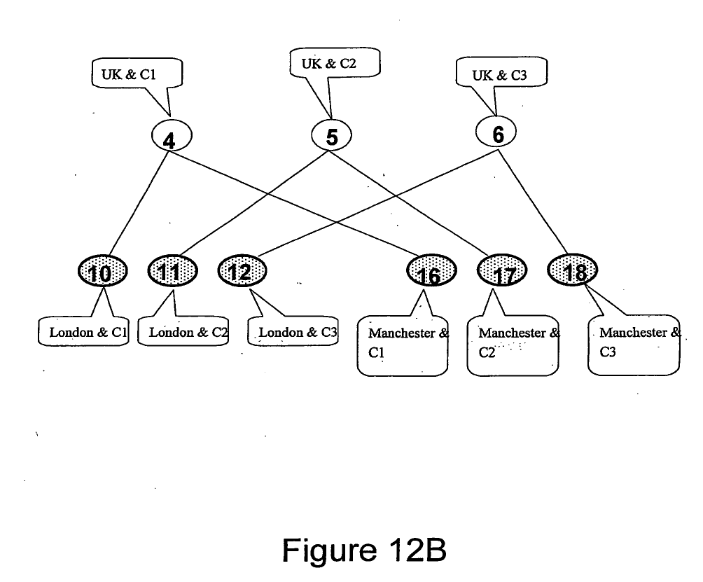

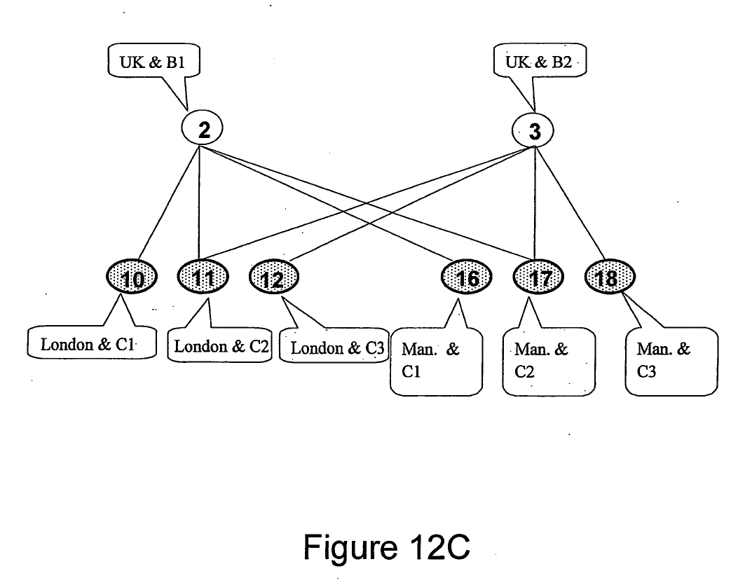

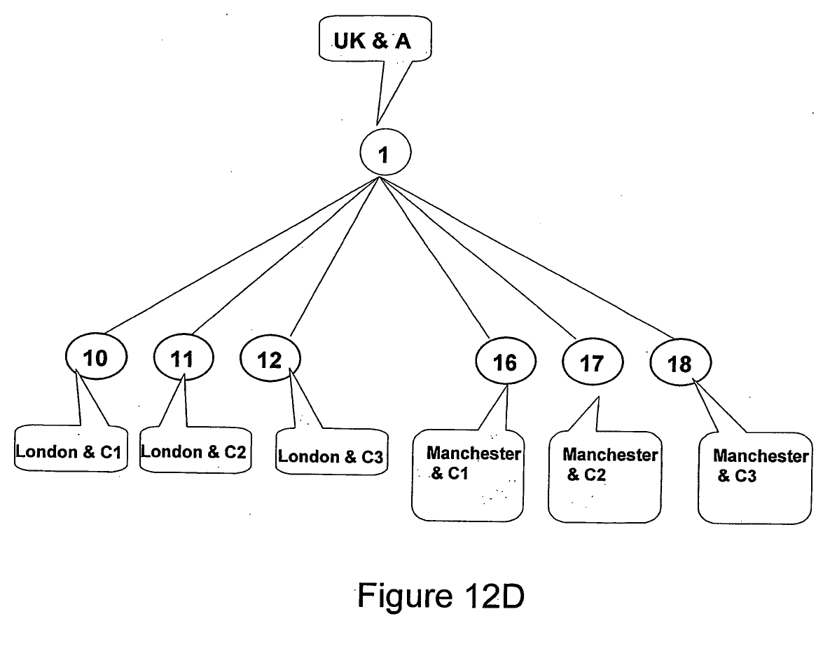

FIGS. 12A, 12B, 12C and 12D show the results of various strategies according to yet another embodiment of the invention.

The best mode of the invention as currently contemplated by the inventors will now be described with reference to the accompanying drawings. Those skilled in the art will appreciate that, for clarity and brevity, features capable of providing equivalent functionality to the features of the embodiments described later hereinbelow which are apparent to those skilled in the art, are considered to be implicitly disclosed by the description, unless such features are explicitly excluded.

The term “time-series” is defined herein to comprise a collection of observations made sequentially thought time, for example, sales of a particular product in successive months and the work demand volumes over a next number of days. The term “time-series forecasting” is defined to comprise a method of computing forecasts based on present and past values of the series. The complexity of this process can range from something simple (like an average of the past 2 historic values) to more advanced mathematical concepts.

FIG. 1A schematically provides an overview of a forecasting system 110 according to one embodiment of the invention. The forecasting system comprises a forecasting application running on an appropriate platform. In FIG. 1A, a forecast data type according to the embodiment of the invention is implemented as part of an application, for example, an enterprise web application written in an object-oriented platform independent programming language such as, for example, Java™ (shown as a J2EE Server-side application 112 in FIG. 1A). The forecasting application is arranged to generate forecasts on work demand for specific types of jobs and geographic areas.

In the forecasting system 110 shown in FIG. 1A, a two user roles are shown, an end user 114 who access the forecasting application via an appropriate user interface 116 (indicated as a web browser in FIG. 1A), and an administrator role 118 who accesses the application via an appropriate interface 120 (shown in FIG. 1A also as a web-browser interface). Information input by the users 114,118 to the application enables a forecast data type according to one embodiment of the invention to be configured appropriately. The application 112 is arranged to retrieve and save time-series data (in the form of the forecast data type) to an appropriate data store, shown in FIG. 1A as database 122. Data store 122 reads the historical values and provides times-series data over which a forecast is to be obtained in a forecast data type format to forecasting engine 124. Data store 124 is also arranged to store forecast data generated by the forecast engine 124 in this embodiment of the invention.

FIG. 1B shows in more detail how the forecast application 12 functions to obtain data over which a forecast is to be provided. Historical time-series data is retrieved by application 12 from an appropriate data store 26 and other data, referred to herein as “external” time-series data as this influences the forecasting process is shown retrieved from external data store 28. The data provided is used by the forecast application 12 to generate a forecast which is saved in forecast data store 24.

Those skilled in the art will appreciate that the distribution of data amongst one or more data stores may differ in different embodiments of the invention.

In order for a forecasting application to be able to implement a forecasting method, it must be provided with appropriate parameters. For example, if a forecast is to be made on the volume of job requests of a particular type over a particular future time period in a particular geographic location, then two parameters might be (a) the geographic location (where the job should be performed) and (b) the type of job. In order to generate the forecast over this set of parameters, both have to be considered by the corresponding forecasting application. In general, however, numerous parameters may be applicable to any time-series forecasting scenario.

The forecasting data type according to the invention represents specific parameters in a generic abstraction. The specific characteristics of any set of forecasting parameters are encapsulated by the generic forecasting data type enabling the forecasting system to be provided with a single interface to the data set on which the forecast is to operate. This enables parameters to be added, removed and even modified without any modification required to the forecasting application. Re-usability and extensibility of the forecasting system is increased.

For clarity, an embodiment of the invention will now be described which is highly simplistic but representative of the invention. In this embodiment, a forecasting application is supported by a suitable hardware platform will generate forecasts for future job requests using a number of data items. This requires the forecasting application to access database information which may be hosted on the same hardware platform as the forecasting algorithm and/or on one or more remote platforms. The database information will contain differing types of information; for example, historical data comprising the volumes (i.e., numbers) of previous job requests, forecast data comprising the forecasted volumes for future job requests, and data representing one or more external factors. An example of an external factor which may or may not influence the forecast is the weather, and thus weather information may also need to be accessed by the forecasting application. Those skilled in the art will appreciate that the database entries accessed may be retrieved from one or more databases, a term which is defined herein to comprise a collection of data records arranged in a systematic manner from which information can be retrieved by performing a look-up operation based on at least one parameter. The physical data records may or may not be co-located on the same physical platform.

FIG. 1C of the accompanying drawings shows the three basic steps required for the forecasting application to generate a forecast using historical information and external factor information. The first step is for the forecasting application to read the data from the Historical and External Factors database tables (step 1 shown in FIG. 1). The forecasting application then generates the forecasts based on some mathematical model (step 2). To enable subsequent forecasts to be generated using the forecast generated by the forecast application, the forecast volume data is stored as appropriate entries in a database which the forecasting application can access (step 3).

The invention enables forecast applications to be developed in which the forecasting algorithm used to generate the forecast in step 2 operates on a generic data type, referred to herein as a forecasting data type. The forecasting algorithm is based on a forecast model (which generates the forecasts according to the particular characteristics of the forecast model). The forecast model is required to access the various time-series of the differing types of information represented as parameters in the database entries.

A forecast model according to the invention is able to access each differing type of parameter time-series in the appropriate context, as the forecast model will receive only set of time-series database entries. According to the invention, a forecast model is provided with does not have any intelligence to distinguish between different parameters etc. An example of History and Forecast database entries such as may be used for a conventional forecasting scenario are shown below in Tables 1 and 2 respectively:

TABLE 1
Historical database entries.

| Geographic Area | Work Type | Date | Value |
|---|---|---|---|
| London | A | 13/02/03 | 20 |
| Manchester | A | 13/02/03 | 14 |
| London | B | 13/02/03 | 22 |
| Manchester | B | 13/02/03 | 8 |
| UK | A | 13/02/03 | 34 |
| UK | B | 13/02/03 | 30 |

TABLE 2
Forecast database entries

| Geographic Area | Work Type | Date | Value |
|---|---|---|---|
| London | A | 13/02/05 | 22 |
| Manchester | A | 13/02/05 | 12 |
| London | B | 13/02/05 | 21 |
| Manchester | B | 13/02/05 | 9 |
| UK | A | 13/02/05 | 34 |
| UK | B | 13/02/05 | 30 |

In Tables 1 and 2, the two parameters (Geographic Area and Work Type) are followed by a specific date and a value. The value denotes how many jobs have been requested or how many jobs have been forecasted to be requested (History and Forecasts table correspondingly). The parameters may be hierarchical in the sense that “Geographic Area” is hierarchical as the United Kingdom “UK” is to be regarded as a parent of “London”, and “Manchester”.

This simple, two-level hierarchical structure is shown schematically on FIG. 2A of the accompanying drawings. In FIG. 2A a parent parameter (parent #1) is shown having two dependent parameters (leaf #1 and leaf #2). A parent parameter is a parameter having at least one dependent, and may itself be a dependent of another parent parameter. A leaf parameter is a dependent parameter without any dependents of its own, and represents the lowest level in the parameter hierarchy, the finest level of granularity of the time-series data.

Consider the case where parent #1 represents the “UK” geographic area parameter and leaf #1 London, and leaf #2 Manchester (these are all geographic areas within the boundaries of the United Kingdom).

In order to generate a forecast, the forecasting application must access and read the relevant parameter information and run the corresponding mathematical formulas. In a conventional forecasting application, the dependence of the forecasting application to access a specific set of parameters limits the extensibility and adaptability of the forecasting system.

In the above example, the forecasting application reads the combinations of all “Geographic Area” and “Work Type” parameters in order to operate. Forecasting on {Area=London, Type=A} and on {Area=UK, Type=A} are two different things. In this embodiment, the forecasting model will assume a strict hierarchical format (like the one for geographic areas shown in FIG. 2A.

In practice, more complex parameter relationships may exist, such as are shown for example, in FIG. 2B of the accompanying drawings. FIG. 2B shows schematically a three-layer relationship is shown between parent parameters #1,#2, #3, and #4 and leaf parameters #1,#2,#3, #4, #5, #6.

FIGS. 3A,3B,4A and 4B show schematically examples of the strategies which may be used to generate a forecast at a particular level of the parameter hierarchy. FIGS. 3A and 3B show how forecasts can be generated at the level of a parent parameter in FIGS. 2A and 2B.

When a forecast is to be generated at the leaf level, if this represents the finest level of granularity of the parametrised data, then generating a forecast can be done as shown in FIG. 4A. FIG. 4B shows schematically, that the finest level of granularity provided in the historical time-series is provided at the leaf level, however, the forecast may be generated based on aggregated data at the level of parents #2,#3,#4 in FIG. 2B. If the forecast is performed based on aggregated data, it is necessary to perform a split-ratio process to obtain forecast data at the parameter level of the leaf-nodes #1 to #6 shown in FIG. 2B

Those skilled in the art will be aware that depending on the forecast model used, each of the conventional strategies shown schematically in FIGS. 3A,3B,4A, and 4B can give different results.

The forecast data type (FDT) provided by one embodiment of the invention is arranged to enable the forecast application to parse the different parameters required by the forecast model and enables different strategies to be applied on the parameters without the need to reconfigure the forecast application.

Effectively, by providing an FDT, the invention ensures that forecast data can be represented at the leaf level in the hierarchy of parameter values. A FDT is able to represent each of the different parameters at the leaf level such as is shown in the example parameter hierarchy illustrated schematically in FIG. 4.

In FIG. 4, four FDT objects are shown, each FDT object representing a different parameter at the leaf level. As an example, the historical information previously shown at the leaf level (of FIG. 2A) in Table 1 can now be represented below in Table 3 as:

TABLE 3
Historical FDT time-series information.

| FDT ID | Date | Value |
|---|---|---|
| FDT #1 | 13/02/03 | 20 |
| FDT #2 | 13/02/03 | 14 |
| FDT #3 | 13/02/03 | 22 |
| FDT #4 | 13/02/03 | 8 |

The information relating to the parent parameter in Table 1, i.e., UK-wide information is no longer required as the abstract FDT represents the leaf parameters in such a way that aggregate data can be determined dynamically as all parent parameter value represents the aggregation of the value of its dependent nodes. There is no need to store in the database the values corresponding to parameters at higher levels of the parameter hierarchy (i.e., any parameter which is not at a leaf node level).

By enabling the retrieval and aggregation of the forecasting data dynamically (i.e., after compiling, e.g., when the forecasting application is running), more complex information can be retrieved it is possible to aggregated data over longer time periods, over larger geographic areas, etc. etc.

The FDT is the only single parameter the software forecasting application needs to access. All the intelligence relating to the context of the data the forecasting model requires is encapsulated within the structure of the FDT. This means that one or more parameters can be added, removed, or modified without impacting the design and/or implementation of the forecasting application.

The invention does not remove the complexity of tampering with parameters from the forecasting system, but instead moves the complexity from the software part to the population of the database.

An important implication of this step is that application developers may now design and implement a product generic enough to accommodate a plethora of differing scenarios, as each scenario is customized by customizing the population of the FDT table entries. This is a simpler and more robust process compared to re-factoring the system's code.

The implementation of the FDT concept has two aspects: one related to the database and one to the software architecture. Database related issues are used during the configuration of the system, while the software issues are used during the generation of the forecast.

An application developer needs to be able to be able to generate specific forecasts, for example, to satisfy each customer's specific requirements. The number and type of parameters that describe the nature of the data to be forecasted may different considerably depending on the required forecast.

According to the invention, an FDT is an abstract aggregation of the different parameters related to the forecasting operation. As an example, consider the case where a forecast is required and historical data is available for only two parameters—geographic area and work type. This is the specific forecast data for the available parameters, which will be referred to herein as “Customer owned” data. A simple database structure must be defined to maps the FDT concept to these available forecast parameters. FIG. 6 shows the schema for the FDT mapping.

In FIG. 6, an embodiment of the invention is shown in which each FDT object associates four different logical entities which collectively apply the relevant context information to the leaf level parameter time-series data. One logical entity is a TB_DOMAIN entity 40 which comprises a set of data arranged to identify the attributes of the FDT object. Another logical entity is a TB_DOMAIN_HIERARCHY entity 42 which comprises a set of data arranged to maintain the hierarchical relationship among all the domain attributes identified by the TB_DOMAIN entity 40. A third logical entity, the TB_FDT_DETAILS data set 44, is arranged to store information associated with each attribute in the FDT object identified in the TB_DOMAIN entity 40. Finally, the a TB_TIME_SERIES logical entity 46 is provided which comprises the data which is used by the Forecasting Application. The TB_TIME_SERIES logical entity 46 is arranged to retrieve the appropriate Historical values for the leaf level parameters which are used to provide data to the Forecasting application by the FDT object, for example, the FDT may modify the historical values of a particular leaf level parameter to ensure the time-series data passed to the Forecasting application has an appropriate context.

In FIG. 6, the attributes of the forecast data type (FDT) are shown in the context of their names. The term “attribute” is defined herein to refer to an attribute of the FDT such as a parameter that distinguishes the TimeSeries data (like Geographic Area and Work Type).

The TB_DOMAIN logical entity 40 shown in FIG. 6 is according to one embodiment of the invention and refers to an embodiment of an attribute logical entity which comprises a data set of all possible attributes of the FDT, examples of which are given below:

i Domain Type: System generated ID to identify each attribute (or in one embodiment the domain) uniquely.

v Domain Desc: Description of the attribute (e.g., in one embodiment the domain)

v Entity Name: Corresponding database table of the “customer owned” database.

v Key Column: Primary key for the physical entity. (primary key column name)

v Parent Key: Parent Key for the physical entity.

The term “primary” key is defined herein to refer to a unique identifier for an attribute of the FDT, for example, any value which distinguishes the different attribute entries in the relevant data store.

The term “domain” is used hereinbelow with reference to the drawings to refer to a specific embodiment of an attribute of the FDT.

For the given, example, one embodiment of an I_Domain_Type structure is shown below in table 4:

TABLE 4
I_Domain_Typ for the exemplary scenario.

| I_Domain_Type | v_Domain_Desc | v_Entity_Name | v_Primary_key | v_Foreign_Key |
|---|---|---|---|---|
| 1 | Area | TB_AREA_DETAILS | v_Area_Id | v_Parent_Area_Id |
| 2 | Work Type | TB_WORK_TYPES | v_Type_Id | v_Parent_Type_Id |

Also shown in FIG. 6 is the TB_DOMAIN_HIERARCHY data set 42 which maintains the hierarchical relationship among all the domain attributes, examples of which are given below:

v Domain Id: Primary key of the corresponding Domain table.

i Domain Type: Type for the domain.

i Parent Domain: Parent Domain of the domain attribute.

i Level: Level of the domain attribute.

V Domain Name: Name of the domain attribute.

Table 5 below provides examples of the attributes which would appear in TB_DOMAIN_HIERARCHY for the given example:

TABLE 5
A TB_DOMAIN_HIERARCHY for the exemplary scenario.

| V_Domain_Id | i_Domain_Type | i_Parent_Domain | i_Level | V_Domain_Name |
|---|---|---|---|---|
| UK | 1 | | 1 | UK |
| London | 1 | UK | 2 | London |
| Manchester | 1 | UK | 2 | Manchester |
| A | 2 | | 1 | Repair |
| B | 2 | | 1 | Provision |

The TB_FDT_DETAILS data set 44 shown in FIG. 6 is a logical entity arranged to store information for each attribute in the FDT, examples of which are given below:

i fdt id: FDT id for which the detail is mentioned.

i domain type: Domain type for the FDT.

v domain id: Domain id for the FDT.

Table 6 below provides examples of the information which appears in a TB_DOMAIN_DETAILS data set 44 for the exemplary scenario:

TABLE 7
a TB_DOMAIN_DETAILS data set for the exemplary scenario.

| I_FDT_ID | i_Domain_Type | v_Domain_id |
|---|---|---|
| 1 | 1 | UK |
| 1 | 2 | Repair |
| 2 | 1 | UK |
| 2 | 2 | Provision |
| 3 | 1 | London |
| 3 | 2 | Repair |
| 4 | 1 | London |
| 4 | 2 | Provision |
| 5 | 1 | Manchester |
| 5 | 2 | Repair |
| 6 | 1 | Manchester |
| 6 | 2 | Provision |

Finally, FIG. 6 shows the TB_TIME_SERIES data set 46 which comprises the data which is used by the Forecasting Application. The TB_TIME_SERIES data set 46 reads the Historical values and provides these values to the Forecasting application and comprises:

i fdt id: FDT id for which the historical value is mentioned.

d date: The corresponding date

n value: The historical value for the corresponding FDT for the given date.

For the exemplary scenario, the TB_TIME_SERIES data set 46 in one embodiment of the invention is shown in Table 8:

TABLE 8
An exemplary TB_TIME_SERIES data set 46.

| I_FDT_ID | D_Date | N_Value |
|---|---|---|
| 3 | 10-Dec-2004 | 100 |
| 4 | 10-Dec-2004 | 120 |
| 5 | 10-Dec-2004 | 113 |
| 6 | 10-Dec-2004 | 100 |
| 3 | 11-Dec-2004 | 122 |
| 4 | 11-Dec-2004 | 114 |
| 5 | 11-Dec-2004 | 98 |
| 6 | 11-Dec-2004 | 104 |

As Table 8 shows, only the leaf level FDTs are stored in the database. The parents in the parameter hierarchy are computed at run time. FIG. 7 of the accompanying drawings shows how the FDT hierarchy will be constructed (based on the TB_DOMAIN_HIERARCHY table).

In FIG. 7, the bold outline circles with the flecked background denote the FDTs at the leaf level of the parameter hierarchy and whose values are actually stored in the database table TB_TIME SERIES.

In order to configure the forecasting system, the tables shown in FIG. 6 are simply populated as appropriate. There is no need to change the available time-series data structures stored in the customer's database and no changes need to be made to the forecasting system code if new parameter(s) are subsequently added to the available data. The forecasting application sees just the TB_TIME_SERIES table and operates on a singe parameter (the FDT).

The next part explains how the software is implemented in order to generate forecasts based on the concept of the FDT.

Once the database tables have been populated (configuration phase), the forecast operation can now be performed.

FIG. 8 shows the main operation. In FIG. 8, a specified TIMER object is executed on specific time intervals and calls the FORECASTSERVICE. This then has the responsibility to “translate” the parameters passed by the TIMER into the corresponding FDT by using the FDTSERVICE class. The FDTSERVICE class reads the database and searches for the FDT information in the tables specified in the previous section. The FORECASTALGORITHM is then implemented in such a way that it operates only on FDT objects. The specific parameters details of each customer are hidden from the FORECASTALGORITHM. FIG. 9 shows a class diagram showing the details of the FDT object.

FIG. 9 represents an embodiment of the ForecastDataType class. In this embodiment, the class has 3 attributes: the unique ID, the set of parent FDTs and the set of children FDTs. The functions implemented for this class are simple get/set methods for the given attributes. They also provide the means for adding/removing a child or a parent FDT at execution time.

In FIG. 10, the various parameters have a non-strict hierarchical parameter structure. If such a scenario occurs, then the database scripts need to be modified in order to populate the TB_FDT_DETAILS and the TB_FDT tables so as to enable the FDT hierarchy (assuming only one parameter for this graph) shown in FIG. 10. This way the aggregation of FDT1 is correct since FDTSA is only accounted once.

A more detailed embodiment of the invention in which a complex parameter relationship exists will now be described. Consider an example in which the FDT information is represented as follows:

Firstly, by a TB_DOMAIN, which in this example is the same as in the previous exemplary scenario, and which is shown below in Table 9:

TABLE 9
TB_DOMAIN

| I_Domain_Type | v_Domain_Desc | v_Entity_Name | v_Primary_key | v_Foreign_Key |
|---|---|---|---|---|
| 1 | Area | TB_AREA_DETAILS | v_Area_Id | v_Parent_Area_Id |
| 2 | Work Type | TB_WORK_TYPES | v_Type_Id | v_Parent_Type_Id |

The TB_DOMAIN_HIERARCHY is modified and it will be will now be modified. This is because we assume that the Work Type hierarchy is now changed from the flat A & B types into the structure shown in FIG. 11.

This type of structure may be represented in TB_DOMAIN_ARCHITECTURE as follows:

TABLE 10
The TB_DOMAIN_ARCHITECTURE data set.

| V_Domain_Id | i_Domain_Type | i_Parent_Domain | i_Level | V_Domain_Name |
|---|---|---|---|---|
| UK | 1 | | 1 | UK |
| London | 1 | UK | 2 | London |
| Manchester | 1 | UK | 2 | Manchester |
| A | 2 | | 1 | Work_Type_A |
| B1 | 2 | A | 2 | Work_Type_B1 |
| B2 | 2 | A | 2 | Work_Type_B2 |
| C1 | 2 | B1 | 3 | Work_Type_C1 |
| C2 | 2 | B1 | 3 | Work_Type_C2 |
| C2 | 2 | B2 | 3 | Work_Type_C2 |
| C3 | 2 | B2 | 3 | Work_Type_C3 |

The TB_FDT_Details data set 44 table will now change to include the following different Work Types:

TABLE 9
TB_FDT_Details data set 44.

| I_FDT_ID | i_Domain_Type | v_Domain_id |
|---|---|---|
| 1 | 1 | UK |
| 1 | 2 | A |
| 2 | 1 | UK |
| 2 | 2 | B1 |
| 3 | 1 | UK |
| 3 | 2 | B2 |
| 4 | 1 | UK |
| 4 | 2 | C1 |
| 5 | 1 | UK |
| 5 | 2 | C2 |
| 6 | 1 | UK |
| 6 | 2 | C3 |
| 7 | 1 | London |
| 7 | 2 | A |
| 8 | 1 | London |
| 8 | 2 | B1 |
| 9 | 1 | London |
| 9 | 2 | B2 |
| 10 | 1 | London |
| 10 | 2 | C1 |
| 11 | 1 | London |
| 11 | 2 | C2 |
| 12 | 1 | London |
| 12 | 2 | C3 |
| 13 | 1 | Manchester |
| 13 | 2 | A |
| 14 | 1 | Manchester |
| 14 | 2 | B1 |
| 15 | 1 | Manchester |
| 15 | 2 | B2 |
| 16 | 1 | Manchester |
| 16 | 2 | C1 |
| 17 | 1 | Manchester |
| 17 | 2 | C2 |
| 18 | 1 | Manchester |
| 18 | 2 | C3 |

FIGS. 12A-12D are all part of the same figure showing the FDT hierarchy, which is split here for the sake of clarity. FIG. 12 A shows the bottom (leaf nodes) and the remaining FIGS. 12B,C, and D show higher layers in the nodal hierarchy. In FIG. 12A the FDTs labeled with the FDT identifiers “10”,“11”,“12”, “16”,“17” & “18” are have a dotted background to indicate they represent leaf nodes in the FDT hierarchy, and therefore the only nodes saved in the database.

If the application requests the generation of forecast at a higher FDT level, this is provided by aggregating the leaf level nodes appropriately, as is shown in FIGS. 12B, 12C and 12D.

Thus in FIG. 12A, FDT with value “7” shows which FDTs (those labeled “10” “11” and “12”) are considered in order to generate the forecasts for LONDON and work type A.

In FIG. 12B, FDT with value “4” shows which FDTs are considered in order to generate the forecasts for UK and work type C1.

In FIG. 12C, FDT with value “42” shows which FDT are considered in order to generate the forecast for UK and work type B1.

Finally in 12D, FDT “1” shows that in order to get a complete system forecast, it is necessary to aggregate of all the leaf nodes.

Thus the invention provides a Forecast Data Type (FDT) which is related to the operation of time series forecasting. In order to produce accurate forecasts, numerous parameters need to be considered like geographic area, type of work etc.

The large number of potential parameters that may be required, in addition to the dynamics of an ever changing customer model, raise the need for a generic forecasting tool. The invention seeks firstly to be able to first accommodate any number and type of parameters, and secondly to be able to modify existing parameters during the operation of the system. By providing a single generic FDT, both issues are addressed as all different forecasting parameters are now abstracted into a single entity.

Those skilled in the art will appreciate that many minor modifications and functional equivalents exist to the features described herein above and the invention is to be considered to include all such modifications and functional equivalents where apparent to those skilled in the art.

1. A method of populating a forecasting system with time-series data, wherein the context of the time-series data is determined by one or more parameters encapsulated within a forecast data type, the forecast data type being arranged to present the time-series data in a generic form independent of any context information to a forecasting algorithm of the forecasting system, wherein the time-series data is encapsulated to enable the forecasting algorithm to generate a forecast for the time-series dependent on said context, the method comprising:
retrieving the time-series data using a generic forecast data type object, said generic forecast data type object being arranged to provide said time-series in said predetermined context, wherein said context presented by said fore-cast data type is capable of changing by said fore-cast data type representing a variable number and type of parameters to the forecasting system without requiring the forecasting system to be re-configured to provide the forecast over the time-series data.

2. A method as claimed in claim 1, wherein the number of parameters providing the time-series data with the pre-determined context is modified by the forecast data type during the operation of the forecasting system.

3. A method as claimed in claim 1, wherein the type of at least one parameter providing the time-series data with its pre-determined context is modified by the forecast data type during the operation of the forecasting system.

4. A method as claimed in claim 1, wherein the forecasting data type is arranged to provide a plurality of parameters which form a hierarchy.

5. A method as claimed in claim 1, wherein the forecasting data type is arranged to provide a plurality of parameters which do not form a hierarchy.

6. A method as claimed in claim 1, wherein said forecast system comprises a forecast application arranged to parse received parameters required by a forecasting model of the forecast system, and wherein the forecast data type (FDT) is arranged to enable said forecast application to parse a plurality of different parameters required by said forecast model to enable a plurality of different forecast strategies to be applied on said parameters without the need to reconfigure the forecast algorithm.

7. A method as claimed in claim 1, wherein the abstract FDT represents leaf parameters of the time-series data over which a forecast is to be obtained.

8. A method as claimed in claim 7, wherein the forecast data type represents leaf parameters in such a way that aggregate data can be determined dynamically and provided to the forecast algorithm.

9. A forecast system comprising a forecasting application and a forecast model, the forecast model being arranged to access a plurality of differing types of parameter time-series, each differing type of parameter time-series being accessed in the appropriate context by the forecast model receiving a set of time-series database entries, in which the forecast model itself is not able to distinguish between different parameters.

10. A forecast data type (FDT) arranged to provide a forecasting system with time-series data having a pre-determined context represented by a predetermined number of differing parameters, each having a predetermined parameter type, the forecasting system comprising a forecasting application arranged to parse the different parameters required by a forecast model of said forecast system, said forecast data type being arranged to provide said parameters in a relevant context to enable different strategies to be applied on said parameters without the need to reconfigure the forecast algorithm.

11. A forecast data type object comprising an object of the forecast data type as claimed in claim 10, in which each FDT object associates four different logical entities which collectively apply the relevant context information to the leaf level parameter time-series data.

12. A forecast data type object as claimed in claim 11, wherein one logical entity comprises a set of data arranged to identify the attributes of the FDT object.

13. A forecast data type object as claimed in claim 12, wherein another logical entity of the FDT object comprises a set of data arranged to maintain the hierarchical relationship among all the identified attributes of the FDT object.

14. A forecast data type object as claimed in claim 12, wherein another logical entity of the FDT object is arranged to store information associated with each identified attribute of the FDT object.

15. A forecast data type object as claimed in claim 12, wherein another logical entity of the FDT object represents said time-series data used by said forecasting algorithm by retrieving appropriate historical values for said leaf level parameters from a data store comprising said historical leaf level parameters and their associated values.

16. A forecast data type object as claimed in claim 15, wherein the FDT object is arranged to represent the historical values of a particular leaf level parameter to ensure the time-series data passed to the forecasting algorithm has an appropriate context.

17. A forecast data type object as claimed in claim 12, wherein said logical entity comprises:
a system generated identifier to identify each attribute uniquely;
a description of the attribute;
a data store associated with at least one other data store arranged to provide leaf-level parameter values.

18. A forecast data type object as claimed in claim 13, wherein said logical entity comprises for each attribute:
a primary key associated with the data store associated with the attribute;
an attribute type;
any parent attribute of the attribute;
an attribute level; an attribute name.

19. A forecast data type object as claimed in claim 14, wherein said logical entity comprises:
the FDT identifier for said forecast data type object;
at least one attribute type for the FDT object; and
at least one attribute identifier for the FDT object.

20. A forecast data type object as claimed in claim 15, wherein said logical entity comprises:
a historical value for the FDT object;
a time value associated with said historical value; and an FDT object identifier for said historical value.

21. A forecasting system arranged to be customized for specific forecasting requirements by customizing the population of the table entries of the forecast data type object as claimed in claim 10.

22. A method of populating a forecasting system with time-series data having a predetermined context represented by a predetermined number of parameters, each having a predetermined parameter type, the forecasting system being arranged to generate a forecast for the time-series dependent on said context, the method comprising: retrieving the time-series data using a generic forecast data type object, said generic forecast data type object being arranged to provide said time-series in said pre-determined context, wherein said context may be presented by said fore-cast data type providing a variable number and type of parameters to the forecasting system without requiring the forecasting system to be re-configured to provide the forecast over the time-series data.

23. A method of forecasting using time-series data comprising the steps of:
encapsulating one or more parameters representing the context of the time-series data within a forecast data type;
presenting the time-series data using said forecast data type in a generic form independent of any context information to a forecasting algorithm of a forecasting system;
populating the forecasting system with time-series data; and
generating a forecast by a forecast algorithm of the forecasting system receiving said the time-series data from the forecast system, and using said data to generate a forecast;
wherein, in said step of populating the forecasting system with time-series data, the time-series data is retrieved using a generic forecast data type object, said generic forecast data type object being arranged to provide said time-series in said predetermined context, and
wherein said context presented by said fore-cast data type is capable of changing by said fore-cast data type object representing a variable number and type of parameters to the forecasting system, wherein said fore-cast data type is arranged to provide a different number and/or type of parameters to the forecast system without requiring the forecasting algorithm to be re-configured to provide the forecast over the time-series data.

24. A method of pre-processing time-series data to populate a forecasting system independently of the type or context of the time-series data, wherein the forecasting system is arranged to generate a forecast for each type of time-series data dependent on said context and type, the method comprising the steps of:
determining the context of each type of time-series data, wherein the context is represented by one or more parameters of one or more parameter types,
mapping each time-series data to one or more forecast data type objects by encapsulating the time-series data and its context within a generic forecast data type, whereby said forecast data type objects are capable of presenting said time-series data and said context in encapsulated form to said forecasting system, whereby said forecasting system populated with said encapsulated time-series data and said context using said generic forecast data type object is arranged to process said received forecast data type objects to generate a forecast for said time-series.

25. A method as claimed in claim 24, wherein said time-series data pre-processed to populate said forecasting system includes data having differing contexts and/or capable of being differently encapsulated with their context(s), whereby said forecast data type objects are arranged to present said differently encapsulated time-series data and context(s) in a generic form to the forecasting system.

26. A method of operating a forecasting system to generate a forecast using a generic data structure, the generic data structure being arranged to encapsulate data at one or more different context levels, the method comprising:
populating the forecasting system independently of the context of the time-series data over which a forecast is to be obtained, wherein the forecasting system is arranged
to generate a forecast for each type of time-series data dependent on said context and type, by:
determining the context of each type of time-series data, wherein the context is represented by one or more parameters of one or more parameter types,
mapping each time-series data to one or more forecast data type objects by encapsulating the time-series data and its context within a generic forecast data type,
presenting said time-series data in an encapsulated form to said forecasting systems using said forecast data type objects, and
processing said encapsulated time-series data to generate a forecast for said time-series, wherein said forecasting system automatically determines from each received forecast data type the context for generating a forecast using the time-series data.

27. A method as claimed in claim 26, wherein the forecast for the time-series data is generated by the forecasting system at the same encapsulation level as the encapsulated time-series.

28. A method as claimed in claim 26, wherein the forecast system generates a forecast using said encapsulated data at a differing level of encapsulation from the encapsulated time-series.

29. A database of stored forecast data type objects, the objects arranged for use in claim 1.

30. Apparatus arranged to support the operation one or more computer programs, wherein said one or more computer programs, when implemented on said apparatus, are arranged to perform appropriate steps in the method of claim 1.
